(19) United States
(12) Patent Application Publication
(10) Pub. No.: US 2013/0174018 A1
(43) Pub. Date: Jul. 4, 2013

(54) PYRAMID REPRESENTATION OVER A NETWORK

(71) Applicant: Sharon AHARONOV, Bnei-Brak (IL)

(72) Inventor: Sharon AHARONOV, Bnei-Brak (IL)

(73) Assignee: CELLPY COM. LTD., Bnei-Brak (IL)

(21) Appl. No.: 13/609,609

(22) Filed: Sep. 11, 2012

Related U.S. Application Data
(60) Provisional application No. 61/533,803, filed on Sep. 13, 2011.

(51) Int. Cl. G06F 17/21

(52) U.S. Cl. CPC G06F 17/21
USPC 715/234

(57) ABSTRACT

Embodiments of the present invention relate to a method including displaying over an Internet webpage a pyramid comprising a hierarchal structure having cells including information. Each of the cells in the pyramid is valued in accordance with its placement along the hierarchal structure. The method further includes accepting user-input, over the webpage, so that the user can obtain one or more cells within the pyramid, and allowing the user to modify the value of the one or more obtained cells within the pyramid. Further, the method includes moving the placement of the one or more obtained cells along the hierarchal structure in accordance with the allowed modification received from the user, and displaying the movement of the one or more cells relative to positions of other cells within the pyramid.

### CROSS REFERENCE OF RELATED APPLICATIONS

This application is a non provisional application claiming priority from provisional application No. 61/533,803 filed on Sep. 13, 2011, the content of which is incorporated herein by reference in its entirety.

### BACKGROUND

1. Technical Field

The present invention relates to scheme used for displaying a status of a user according to a financial or other types of value(s) ascribed to a manner by which the status of the user is displayed.

2. Discussion of the Related Art

Digital networks, such as the Internet, have become a general platform for individuals, companies and other public and/or private institutions for making the general public aware of their ideas, opinions, news, products, advertizing material and much more information of main interest to almost anyone who has access to such networks.

Notwithstanding such wide exposure to the public at large, including private individuals, company personnel, public officials and the like, many end users still grapple with prospects of using the Internet as a tool for self promotion or advertizing. Hence, most people may not technically savvy to the extent they can bring forth, much less, implement a web application, such as a webpage or web portal, for addressing their advertizing and/or marketing needs. Hence, in this aspect, network infrastructure may remain largely inaccessible for allowing users to specifically show and share the general public the manner by which such users can standout through advertizing of their products, or event some aspect of their personal lives. In addition, viewers of websites may not always be able to obtain objective information regarding products, services, people, and opinions in manner that is readily convenient and optimal. Accordingly, users may not obtain an appropriate exposure to a full range of options normally offered on the web.

### BRIEF SUMMARY

Exemplary embodiments of the present invention disclose a system adapted to provide an advertizing platform for a user. Specifically, through a web graphical interface, such as that provided by a webpage, a user is provided with a hierarchal structure in a form of a pyramid through which the user can display and share the user's social status, advertizing material, products, informational material and other related media. Accordingly, the pyramid includes of multiple rows whereby each row may contain multiple cells, whereby each cell may be associated with one or more users. The pyramid structure provides a platform for ranking various form of information relating to people, companies, affiliations and other public or private organizations and entities.

Further, each cell within the pyramid is priced according to a certain value, whereby the user can purchase one or more cells within the pyramid and, furthermore, increase the value of the purchased cell by either adding money to the value or by receiving input, such as popularity data, from other users. Accordingly, an increase in value of the one or more cells advances the cell up the pyramid, thereby elevating its status to other cells of other users within the pyramid. Hence, the present technique is very well suited for advertisement of products and/or individuals and could be embedded within social networks and/or other web venue, such as web blogs, gaming sites, and so forth, adapted for displaying a pyramid-like ranking of the individuals and/or the products at hand.

According to other aspects of the present invention, the aforementioned pyramid structure may be embedded within websites of users, vendors and the like, whereby users may access and use the pyramid structure without cost, that is, the use of the pyramid may be made free to the users. Alternatively, the pyramid structure may be provided as part of a service with cost to vendors, distributors, website owners, advertisers and the like for enabling user to view, access and influence pyramid ranking and other attributes associated with the hierarchal structure provided by the present scheme.

Other aspects of the invention may include a system arranged to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a network diagram, in accordance with an exemplary embodiment of the present technique.

FIG. 2 is a view of a webpage, in accordance with and exemplary embodiment of the present technique.

FIG. 3 is a view of a webpage cell, in accordance with an exemplary embodiment of the present technique.

FIG. 4 is a view of a hierarchal structure appearing in a webpage, in accordance with an exemplary embodiment of the present technique.

FIG. 5 is a block diagram describing a process, in accordance with an exemplary embodiment of the present technique.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

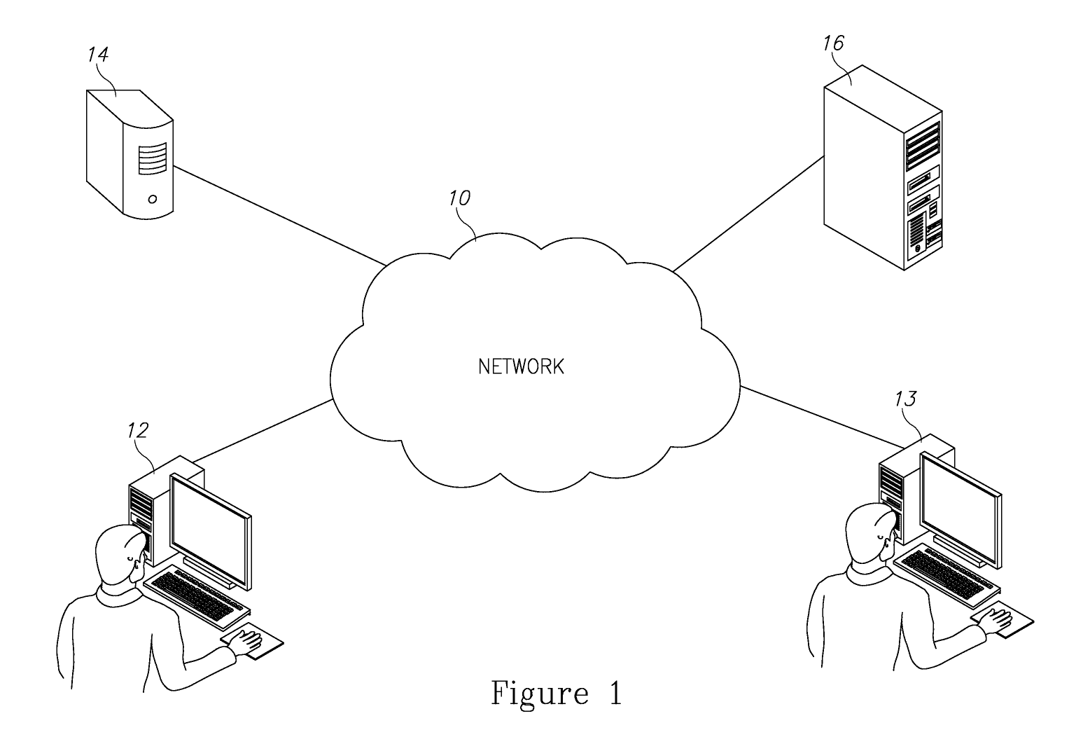

Referring now to the figures, particularly, FIG. 1 is a network diagram, in accordance with an exemplary embodiment of the present technique. Accordingly, the figure depicts a communications network 10 adapted for connecting various nodes, such as servers, computer systems and end users, as well as for facilitating the transfer of data between the nodes and end users. As described further below, such nodes may further include servers, computers, fax machines, routers, cell phones, hand held devices and/or other digital and/or non-digital devices. Further, the network 10 may be an Internet network, an Intranet, or other types of local, wide and/or global area communications network. Hence, the network 10 may include a wire line network, wireless network, satellite network, or a combination thereof.

As illustrated by FIG. 1, the nodes/endpoints/end users, connected and forming the network 10 include the user endpoints 12 and 13, as well as, servers 14, and central computing system (CCS) 16. The user 12 and/or 13 may be client computers such as a home or office personal computer (PC), a remote client, a thin client or other type of computer and/or processing interface adapted for general data processing and for connecting to the network 10. Although not illustrated by the FIG. 1, the client computers may further be coupled and/or connected to other peripheral devices, such as monitors, keyboards, mice, printers, routers, wireless devices, microphones, speakers, cameras, finger print identifiers, external memory devices, and other devices. The PC 12 may include software platforms and operating systems, such Windows, Linux—Red Hat, and other supporting programs.

Further, the server 14 and CCS 16 may be adapted for storing, routing and/or communicating data within the network 10 and/or other networks to which those the server and CCS may be connected. In an exemplary embodiment, the server 14 may be of the type available by Sun Microsystems, Hewlett Packard, Dell, International Business Machines (IBM), and/or other known server vendors and providers. Accordingly, the server 14 and the CCS 16 may include various hardware devices, such as microprocessors, memory cards, graphic cards, routers, wireless devices and other modules for receiving, transmitting and/or processing data. In addition, the servers may include various software platforms and packages, such as those providing code written in Java, Python, Ruby on Rails, and/or other computer languages, for facilitating the everyday operation and use of the server 14 and CCS 16 as part of the network 10. It should further be borne in mind that the user nodes 12 and 13 and the servers 14 and CCS 16 are exemplary, and that the network 10 may include many other additional user nodes similar to the users 12 and 13, as well as, multiple other servers similar to the servers 14 and CCS 16.

Further, the server 14 may be adapted to store data, such as websites, generally accessible to the user 12 and/or 13 via the network 10. Those skilled in the art will appreciate that each website accessible, for example, to the user may contain multiple web pages which may also be accessible to the user 12 upon request. For example, the server 14 may store websites of private companies and/or corporations, as well as government and/or other pubic organizations. Hence, the server 14 provides access to the user 12 of web pages provided by the above mentioned private or public entities so that the user, for example, can conduct business and/or manage various tasks through the network 10. For instance, the user 12 may access the server 14 for downloading a webpage belonging to a vendor through which the user 12 may perform financial transactions such as when purchasing consumer items or the like. By further example, the user 12 may access the server 14 for downloading webpages associated with a medical institution for providing personal medical information or other related data. Still, by further example, the user 12 may download, via the server 14, a government webpage through which the user 12 can provide personal and/or other type of information for conducting everyday personal and/or work-related business and so forth. Accordingly, the user 12 and the server 14 may generally form communication sessions during which the user 12 and server 14 exchange information through the network 10.

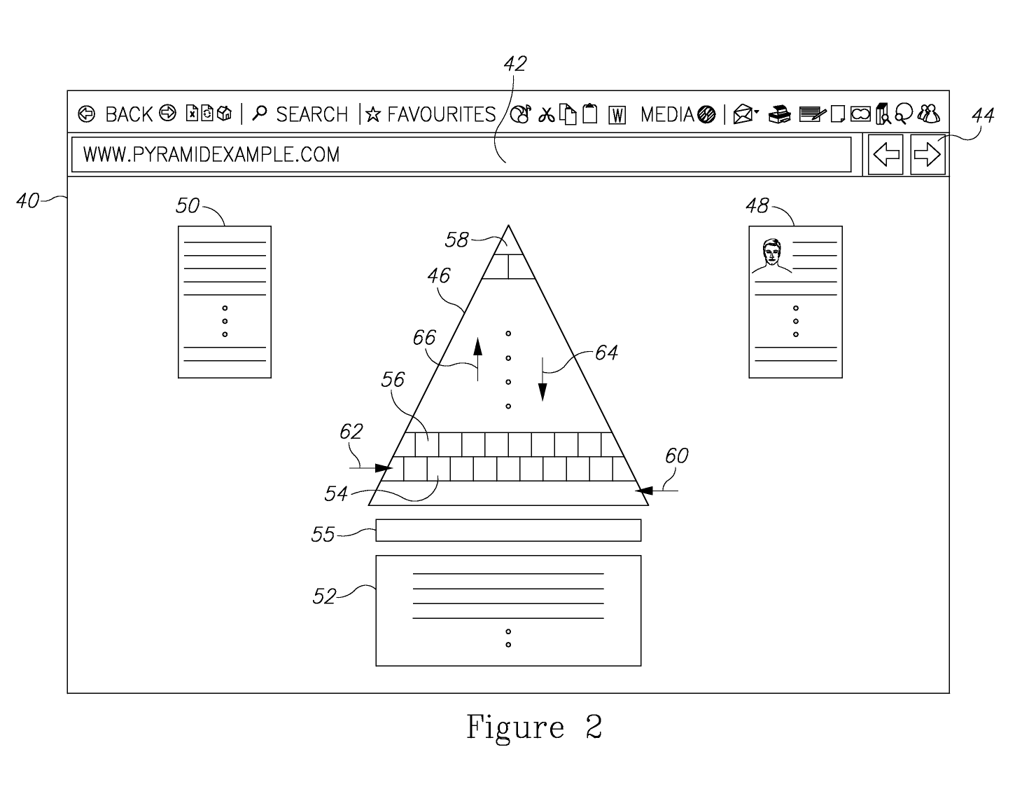

FIG. 2 is a view of a webpage, in accordance with and exemplary embodiment of the present technique. Accordingly, a webpage 40 is illustrated, including an address bar, as well as browsing arrows 44 and other standard features normally included in general website. The webpage 40 can be created managed and/or otherwise manipulated by the CCS 16 and it also can be made available and downloaded by the users 12 and/13 from the server 14.

Further, the webpage 40 further includes a hierarchal structure 46 in a form of a pyramid, as well as information windows 48, 50 and 52. The pyramid 46 further includes cells 54, 56 and 58, each of which is adapted to display information relating to user(s), such as personal information users would like to share with other people or advertizing information of products, services and the like made available by the users, companies or firms that desire to expose information relating to their existence and operation. Hence, the cells may contain text material, images, logos, movies and/or other digital media. The number of cells, i.e., cells 54-58 within the pyramid 46 can be predetermined or varied in accordance with certain conditions or terms specified by users, vendors and/or other general spectators associated with the webpage 40 and/or with the pyramid 46. In one embodiment, the pyramid may be configured to have 100 cells while in other embodiments it may be configured to have 1000, 10000 or an arbitrary number of cells. Although not shown, certain cells within the pyramid 46 may be labeled as “tailing cells” (e.g., region 55) for indicating those cells that are not shown as part of the hierarchal structure but are, nonetheless, part of a lower part of the pyramid. The region 55 includes those cells not viewable by a user in a current view of the website. However, it should be borne in mind that the cells included within the region 55 are part of the pyramid and may become viewable at some point in the future. In other words, a pyramid may be viewed to have a certain number of cells, however, this does not mean that the pyramid has only those numbers of cells shown to the viewer. Thus, the viewer can view cell included within the region 55 to view their general status, as well as elevate those cells' ranking and value so that they may obtain higher portions and/or tiers of the illustrated pyramid.

Accordingly, the pyramid may have other available cells not necessarily shown in a view available to the user. Such lower laying cells or those cells not currently shown may indicate cells having lower or diminished value, either in terms of cash value or in terms other scoring and/or ranking schemes, i.e., gaming, “likes”, etc. Although the pyramid 46 may contain a large number of cells, managers or other administrators of the webpage 40 may set or otherwise limit the number of participants or cell owners of the pyramid. Such attributes may be determined in accordance with the topics or the content of the pyramid 46. For example, the pyramid 46 may pertain to the rankings of celebrities, i.e., movie stars, pop singers and the like. In order to avoid an over crowding or to increase exclusivity, such pyramids may be restricted only to certain celebrities, such as those obtaining a minimal score or having minimum cash value.

In some embodiments, a pyramid may include participants, i.e., celebrities, movie starts, politicians, and the like, whereby a number of the participants within the pyramid remains constant and is determined by preset factors or parameters. However, the number of cells appearing in such pyramids may be determined by the actual size of the pyramid, which can also be predetermined according to certain preset factors. Those participants not shown in the pyramid but are part of it, may be included in the tailing cells of the pyramid.

Further, the pyramid 46 and/or those similar to it may have an expiration date, or a lifetime, such as that specified by the topic or venue in which the pyramid is displayed. Accordingly, in one example, the expiration of the pyramid 46 may be determined by duration of an Internet game sequence in which the users 12/13 and or other spectators of the pyramid participate in the game. By further example, the expiration of the game may be determined by a certain event, such as a holiday, New Years, or other happening, generally independent of the pyramid 46. In addition, cells within each pyramid may also have an expiration date, or such cells may expire in accordance with certain criteria, as determined by pyramid administrator, manger, or other individuals overseeing the distribution and operation of the present technique.

Accordingly, in one embodiment, each of the cells 54-58 within the pyramid 46 has a monetary or cash value, determined by its location within the pyramid 46. That is, the higher the cells are within the pyramid the greater their cash value. Thus, for example, the user 12, such as a person or company, may purchase the cell 54 at a certain price in accordance with its value within the pyramid. The user 12 can advance within the vertical and horizontal structures within the pyramid by adding paying more money, that is, adding value to the cell(s), as desired by the user. Thus, for example, the user can advance the cell 54 to the location of cell 56 and ultimately to the cell 58, i.e., the apex of the pyramid, thereby reaching the highest status and value within the pyramid.

In other embodiments the pyramid 46 can be defined as a “free of charge” pyramid where the user 12 can advance within the vertical and horizontal structure of the pyramid according to certain data contained within the pyramid. Accordingly, each of the cells 54-58 may include data, such personal data, advertizing data, popularity data (“likes,” done in facebook, linkedin and other social networks), product data, public data, celebrity names and related information, and/or any other information that could be made available to the general public originating from personal, public or corporate websites. Thus, for example, the user 12, owning/occupying cell 54, can received multiple “likes,” or popularity rankings, such as those used in facebook, however, not resulting or originating from the aforementioned facebook website, but popularity ranking associated only with the current website on which the pyramid is shown. Such popularity rankings for the user and/or from other users (e.g., user 13) are further adapted to advance the status of the user 12 to cell 56 within the pyramid, for example.

Further, the information windows 48-52 are adapted to include other types such of dynamical or static information, such as talkbacks, chats, “flash video” and other advertizing material. In one embodiment, for example, the window 48 may, among other things, include a “chat” window for allowing two users, i.e., 12 and 13, occupying/owning cells 54 and 56, respectively, within the pyramid 46 to conduct a chat session on topics that may relate to other information in the pyramid. Similarly, in other embodiments, the window 48 may also enable general users, other than the owners/occupiers 12 and 13, and/or spectators of the pyramid 46 to chat and interact about topics of interest, such as those appearing in the pyramid 46 and related information. Accordingly, the users 12 and 13, may exchange all sorts of data through the window 48 to could either advance or demote their status within the pyramid 46. Further, the window 52 may allow users to conduct “talkback” sessions regarding different celebrities occupying cells 54-58 within the pyramid 46. Hence users may comment on celebrities and/or event relating to the celebrities that could elevate, demote, or otherwise alter the celebrities' statues within the pyramid 46.

Those skilled in the art will appreciate that the present pyramid may include a forum discussion, such as talkbacks, relating to the topic with which the pyramid deals. Such forums can take place outside the pyramid, such as in information windows 48 and 50, or alternatively, such discussions can take place within the cells 56. In addition, chat conversations can be opened with any one of the cells of the pyramid 46, whereby such discussion can be limited to only the cell users/viewers, or owners or, the discussion can be open to everyone having access to the website on which the pyramid is shown. The aforementioned chat sessions can also be filtered and controlled by the cell viewers, owners, or any other administrators overseeing the pyramid 46.

Further, advancement along the pyramid may be done left to right (as indicated by arrows 60 and 62) or the advancement may be done in a right to left pattern (not show). Hence, users can perform direct horizontal and/or vertical movement (as shown by arrows 64 and 66) along the pyramid to advance or retract to cells located on their sides or cells located above or below relative to those they currently occupy. As will be appreciated, advancement vertically upward along the pyramid may indicate heightened value in price of the cells and could also be attained based on exclusivity, popularity and acceptance of the occupiers/owners 12/13 by other users, such as those viewing the webpage 40 and/or by the user/owners 12 and 13 themselves within the pyramid 46. In this regard the pyramid 46 may be used as a communication tool for self promotion and self exposure of an individual or a company. It should also be born in mind that owners/occupiers 12/13 of the cells within the pyramid 46 may advance based on particular scoring schemes based, for example, on certain scores obtained via Internet games, social network sites and/or other Internet platforms. For example, users achieving more than a certain numerical value (e.g., 15, 25, 10000) may be able to advance along certain cell(s), tiers, levels, or other benchmarks defined within the pyramid. In addition, the pyramid 46 can also be used to display the popularity and likability of certain individuals, events, movies, music, books, regions, cities, cuisine, restaurants, sporting events, speeches, opinion columns and much more.

In this regard, the pyramid 46 may include rankings, for example, of restaurants based on various factors such as food quality, service quality, hygiene, general atmosphere, location, accessibility and other factors contributing to a general score of the restaurant as compared to other restaurants within the pyramid.

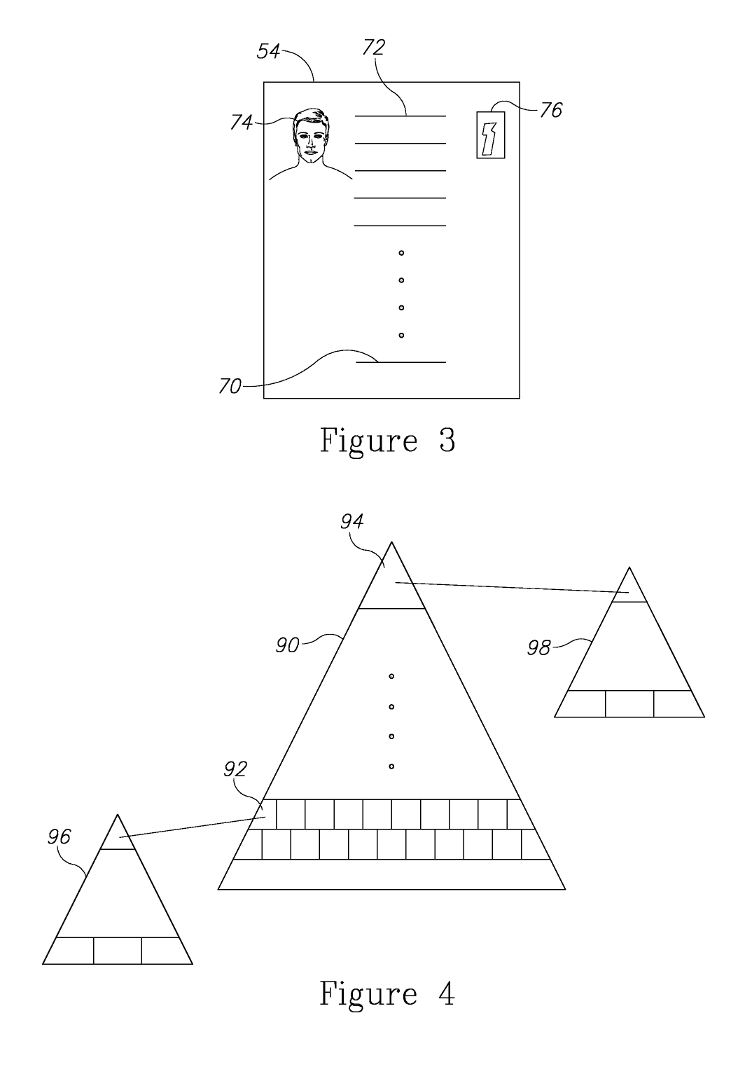

A more detailed view of the cell 54 is provided by FIG. 3, in accordance with an exemplary embodiment of the present technique. Accordingly, cell 54 includes textual inputs 70 and 72 as well as image inputs 74 and 76. Accordingly, the inputs 70 and 72 may include a variety texts in various forms and shapes, as well as information in various languages and contain links to various websites on a whole host of topics, including political, social, geographical, scientific, trivia, and other general and newsworthy information, some of which may be related to user 12, 13 and some of which may be unrelated to the users. Accordingly, the user owner, or any of those individuals ranked by the pyramid, such as those individuals occupying cell 54, as well as, the general public viewing or otherwise interacting with the pyramid 46 can indicate their online availability or readiness for receiving communication from other cell users/owner and spectators of the pyramid 46. Hence, to the extend memory and web space is available to each of the aforementioned cell 54, the pyramid 46 may contain information of unlimited breadth and may cover topic of a wide scope, limited only by the imagination and creativity of the users themselves. The cell 54 may also be adapted to receive information and communication from other users/owners of the pyramid 46, as well as from the general public viewing and interacting with the pyramid 46.

Further, the image 74 of cell 54 may include an image of the user 12 and/or other people, i.e., celebrity, as well as other related images of objects and/or varying views, all of which can be manipulated by the user 12. Furthermore, the image 76 may include a logo of a company or other institution, web address, or other promotional information. In addition, the cell 54 can be edited and formatted to include other images, pictures, substance, links, texts, and the like in accordance with owner preferences.

FIG. 4 is a view of a hierarchal structure appearing in a webpage, in accordance with an embodiment of the present technique. Accordingly, hierarchal structure 90 is a pyramid structure, similar to the pyramid 46 shown in FIG. 1, however, the pyramid 90 is a parent structure encompassing an ensemble of many child pyramids such the pyramid 46. Thus, as illustrated, cells 92 and 94 represent child pyramids 96 and 98 organized in a hierarchal structure of the pyramid 90. Hence, the parent pyramid 90 represents a grouping of child pyramids sharing similar characteristics and attributes. For example, the pyramid 90 may be labeled as a celebrity pyramid, whereby the child pyramids 96 and 98 form celebrity pyramids of two different countries. By further example, the child pyramid 90 may be adapted to group child pyramids related to types of restaurant in a certain city, whereby the user can view or contribute to the ranking of the restaurant in a certain region. The aforementioned grouping, as performed by the pyramid 90, can facilitate a better organizational scheme for viewing and sorting information for the user 12 and/or 13. It should further be born in mind that each cell, i.e., cell 54, contained within the child pyramid 96 has a representation within the parent pyramid 90 for maintaining, ascribing or comparing rankings of similar child pyramids contained within the parent pyramid 90.

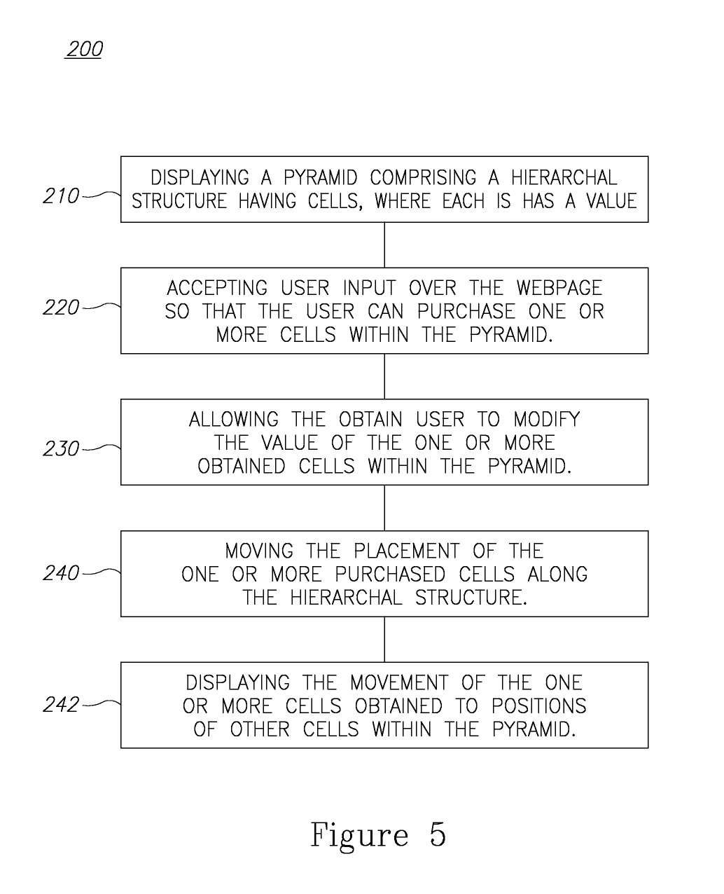

FIG. 5 is a block diagram describing a process, in accordance with an embodiment of the present technique. Block diagram 200 describes a general method for displaying and ranking information along a pyramid structure as described above by FIGS. 1-4. It should be borne in mind that the description of diagram 200 utilizes and makes reference to structures and elements already mentioned above in the foregoing discussion.

Accordingly, the block diagram includes a process 210 in which a pyramid (e.g., 46) having a hierarchal structure is displayed for the user, as may be done through a webpage (e.g. 40). The pyramid further includes multiple cells organized along rows within the pyramid such that the number of cells reduces vertically upward along the pyramid. In the exemplary embodiment, each cell within the pyramid is valued, for example to have certain rankings, points, “likes” and/or price, in accordance with the cell's placement within the pyramid. Other embodiments may also include pyramids free of charge and have rankings based on points acquired through games and/or other Internet based venues such as social networks, blogs and the like. Still in other exemplary embodiments, ranking of the cell 56 within the pyramid 46 may not be related to the cell's value, such as to its monetary or cash value, unless the pyramid 46 is defined as a pyramid in which advancement within the pyramid can only be achieved by adding cash value to an already purchased cell.

Hence for obtained cells, the block 200 further includes a process 220 whereby the user can provide input, such as scores, likeability, rankings and/or payment, over the webpage for enabling the user to obtain one or more cells within the pyramid according to the placement and value of the cell within the pyramid. As further noted by block 230, the present technique allows the user to modify the value of the aforementioned obtained cell by adding value to the cell already in possession of the user. Alternatively, the value of the one or more cells can be altered by receiving input from other user which can increase or decrease the value of the cell. Such input may include popularity notifications (e.g., “likes” in facebook, linkedin and so forth), talkbacks, as well as other textual or gestural notifications.

Hence, in accordance with the block diagram 200, particularly, as established by block 240, the placement of the one more obtained cells along the pyramid (e.g., 46) may be moved so as to promote or demote its ranking within the vertical and horizontal hierarchal structure, as provided by the pyramid. Thus, the user (e.g., 12) who occupies the cell and/or other users (e.g., 13), as well as the general public, not associated with the users 12/13, viewing and interacting with the pyramid structure may also bring about a change in the position of the one or more cells contained within the pyramid. Consequently, at block 242 the movement of the one or more obtained cells is displayed to the user such as on a screen of a computer monitor used by the user or other spectators when interacting with the webpage 40 and the pyramid 46. In so doing, users and other spectators can view how particular cells or multiple cells are moving along the pyramid relative to other cells, some of which may be owned or used by other users.

According to some embodiments of the present invention, some of the cells and/or some of the pyramids may be assigned with an expiry date after which the content in these corresponding cells and/or pyramids will become inactive so that the cell could not be rated anymore and/or a corresponding pyramid will become disabled. Such a disabled pyramid may still be visible and should not necessarily be deleted, in accordance with the pyramid manager decision. The expiry date may be assigned either by the user or the publisher, or the pyramid manager as the case may be.

According to some embodiments of the present invention, some of the cells may be interrelated in a plurality of pyramids so as to appear simultaneously in several pyramids, possibly in different locations, but while preserving the data stored therein. Although information in the cell migrates from one pyramid to another, the rating of a specific cell in the various pyramids will be based on the cell's specific rating in each one of the pyramids that includes the specific cell.

According to some embodiments of the present invention, some of the data in the cells may be copied or transferred automatically from a personal website or database of the user in a seamless manner. A special case is that the user is a pyramid manager so that the information relating to a cell is provided from a website of the pyramid manager.

Notwithstanding the above, according to some embodiments of the present invention, the cells are arranged in geometrical layout which is hierarchically allotted based on the various ratings in the cells. The geometric layout may be in the form of a pyramid but can be any other geometric layout that expresses hierarchal ordering. It should be stated though that the pyramid is a default implementation of the present invention.

What is claimed is:

1. A method, comprising:
displaying, over an Internet webpage, a pyramid comprising a hierarchal structure having cells including information, wherein each cell in the pyramid is valued in accordance with its placement along the hierarchal structure;
accepting user-input, over the webpage, so that the user can obtain one or more cells within the pyramid;
allowing the user to modify the value of the one or more obtained cells within the pyramid;
moving the placement of the one or more obtained cells along the hierarchal structure in accordance with the allowed modification received from the user; and
displaying the movement of the one or more cells relative to positions of other cells within the pyramid.

2. The method according to claim 1, wherein the value comprises at least one of a ranking value, monetary cash value, a game score value, and/or popularity score value, number of views of the cells, and/or a number of views of the pyramid, or any combination thereof.

3. The method according to claim 1, wherein allowing comprises obtaining payment, and/or score ranking from the user to elevate the one or more cells along hierarchal structure of the pyramid.

4. The method according to claim 1, wherein the information included within each cell comprises data associated with the user and/or data associated with users other than the user, and/or the number of view of the cells, and/or a number of views of the pyramid.

5. The method according to claim 1, wherein the information included within each cell comprises images, or labels, or advertisement data, or popularity data, or political affiliations data, or demographic data, or any combination thereof.

6. The method according to claim 1, comprising modifying the placement of the one or more obtained cells along the hierarchal structure in accordance with input provided by users other than the user.

7. The method according to claim 6, wherein the input provided by the other users is performed, over websites, social networks, wireless networks, institutions, intranets, a gaming network, and/or over Internet blog or any combinations thereof.

8. The method according to claim 1, wherein the information within each cell can be modified by the user.

9. The method according to claim 1, wherein at least some of the cells and/or some of the pyramids are assigned with an expiry date after which the content in these corresponding cells and/or pyramids will become inactive so that the cell could not be rated anymore and/or a corresponding pyramid will become disabled.

10. The method according to claim 1, wherein at least some of the cells are interrelated in a plurality of pyramids so as to appear simultaneously in several pyramids while preserving the data stored therein, and wherein when information in the cell migrates from one pyramid to another, the rating of a specific cell in the various pyramids is based on the cell's specific rating in each one of the pyramids that includes the specific cell.

11. The method according to claim 1, wherein at least some of the data in the cells is copied or transferred automatically from a personal website or database of the user in a seamless manner.

12. The method according to claim 1, wherein the cells are arranged in geometrical layout which is hierarchically allotted based on the various ratings in the cells.

13. A system comprising:
a network server adapted to provide a graphical interface for displaying, over an Internet webpage, a pyramid comprising a hierarchal structure having cells including information, wherein each cell in the pyramid is valued in accordance with its placement along the hierarchal structure;
and
a central computing system adapted to
accept user-input, over the webpage, so that the user can obtain one or more cells within the pyramid;
allow the user to modify the value of the one or more obtained cells within the pyramid; and
move the placement of the one or more obtained cells along the hierarchal structure in accordance with the allowed modification received from the user; and
display the movement of the one or more cells relative to positions of other cells within the pyramid.

14. The system according to claim 13, wherein the value comprises at least one of a monetary cash value, a game score value, and/or a popularity score value, number of views of the cells, and/or a number of views of the pyramid.

15. The system according to claim 13, wherein the central computing system obtains payment from the user to elevate the one or more cells along hierarchal structure of the pyramid.

16. The system according to claim 13, wherein the information included within each cell comprises data associated with the user and/or data associated with users other than the user, and/or the number of view of the cells, and/or a number of views of the pyramid.

17. The system according to claim 13, wherein the information included within each cell comprises images, or labels, or advertisement data, or popularity data, or political affiliation data, or demographic data, or any combination thereof.

18. The system according to claim 13, wherein the central computer system is further adapted to move the placement of the one or more obtained cells along the hierarchal structure in accordance with input provided by users other than the user.

19. The system according to claim 18, wherein the input provided by the other users is performed over at least one of a social network, a gaming network, and/or over Internet blogs websites, social networks, wireless networks, institutions, intranets or any combination thereof.

20. The system according to claim 13, wherein at least some of the cells and/or some of the pyramids are assigned with an expiry date after which the content in these corresponding cells and/or pyramids will become inactive so that the cell could not be rated anymore and/or a corresponding pyramid will become disabled.
